(19) United States
(12) Patent Application Publication
(10) Pub. No.: US 2018/0108030 A1
(43) Pub. Date: Apr. 19, 2018

(54) Data Label Distribution

(71) Applicant: Alibaba Group Holding Limited, Grand Cayman (KY)

(72) Inventors: Wanli Sun, Hangzhou (CN); Xianhui Wei, Hangzhou (CN)

(73) Assignee: Alibaba Group Holding Limited

(21) Appl. No.: 15/782,798

(22) Filed: Oct. 12, 2017

(30) Foreign Application Priority Data
Oct. 13, 2016 (CN) 201610893898.9

(51) Int. Cl. G06Q 30/02; H04L 29/08

(52) U.S. Cl. CPC G06Q 30/0224; H04L 67/025; G06Q 30/0239; G06Q 30/0222

(57) ABSTRACT

A data label distribution system including a search server, a distribution server, and at least one client terminal. The client terminal communicates with the distribution server. The client terminal receives a search term input by a user. The distribution server receives the search term from the client terminal and distribute the data label to the client terminal according to the search term. The search server receives the search term, and returns the search result to the client terminal according to the search term. The client terminal display both the data label and the search result concurrently. The technical solutions of the present disclosure increase the probability that the data labels, such as coupons or red-envelopes, are collected and used by the user, thereby improving the active degree of the user of the platform or website of which the user visits or has an account.

### CROSS REFERENCE TO RELATED PATENT APPLICATIONS

This application claims priority to Chinese Patent Application No. 201610893898.9, filed on 13 Oct. 2016, entitled “Data Label Distribution System, Method, Server, and Client,” which is hereby incorporated by reference in their entirety.

### TECHNICAL FIELD

The present disclosure relates to the field of Internet information processing technology, and, more particularly, to a data label distribution system, method, server, and client, a data label display method, and a user interaction method applied at the client.

### BACKGROUND

With the continuous development of Internet technology, more and more people are starting to shop for various products or services, from home appliances to toothpaste and toothbrush, via online shopping platform. There are also more and more online shopping platforms. With respect to the shopping platforms, how to effectively keep users and increase the active degree of the users have become urgent problems.

Currently, various online shopping platforms generally provide shop celebration activities, all-platform promotions on specific days, etc. Typically, the continuous promotion activities are coupons. Typically, the types of coupons mainly include two types:

A first type of coupon is a red-envelope coupon or certain dollar off coupon provided by a merchant at the online shopping platform. When the user visits the merchant shop, a front page or detailed product information page of the merchant shop provides a reminder of collecting coupon. If the user shops at the merchant shop and is qualified to use the coupon, the user may use the coupon to deduct payment.

A second type of coupon is to set the coupon reminder at the front page of the activities of the online shopping platform. All users may collect the coupons.

There is no difference in the methods for pushing the two types of coupons. Both are freely distributing coupons at the website. All users of the online shopping platform may collect these coupons. The work of the online shopping platform is to display the coupons to the users and the user may collect the coupons per their personal preferences.

As such methods for distributing coupons cannot differentiate users, all users of the online shopping platform may obtain these coupons. On one hand, the user may receive too many coupons by such untargeted distribution and find difficulty in choosing among the coupons. On the other hand, many coupons are not needed or currently needed by the users and thus the user may not have an incentive to use the coupons. Thus, the coupons cannot be effectively used to increase the active degree of the user.

Currently there is no effective solution of the above problems.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a method comprising:

receiving a search term from a client terminal;

distributing one or more data labels and one or more search results corresponding to the search term to the client terminal; the data labels being specific to a user of the client terminal; and

requesting the client terminal to display the one or more search results at a first region of a user interface of the client terminal and the one or more data labels at a second region of the user interface of the client terminal. For example, the first region and the second region are located on a same display page of the user interface.

For example, the data label is not some general coupon to an unspecific user, such as an ordinary $20 off $100 coupon. Instead, the data label is specific to the user of the client terminal. The data label may be generated in real time or selected from a coupon database according to information of the user based on the information obtained from the client terminal

For example, the distributing the one or more data labels and the one or more search results corresponding to the search term to the client terminal includes:

obtaining user information of a user corresponding to the client terminal; and

distributing the one or more data labels to the client terminal according to the user information and the search term.

For example, the user information includes at least one of:

historical purchase record of the user;

historical saving record of the user; and

historical visiting record of the user.

For example, the distributing the one or more data labels to the client terminal according to the user information and the search term includes:

determining a classification of the user according to the user information; and

distributing the one or more data labels to the client terminal according to the classification of the user and the search term.

For example, the classification includes at least one of:

a new user that has registered an account at a website and has not conducted transaction;

a potential churning user that has not logged into account for a first preset threshold of time;

a churning user that has not logged into the account for a second preset threshold time, the second preset threshold of time being longer than the first prese threshold of time; and

a normal user that is not classified as the new user, the potential churning user, and the churning user.

The method may further comprise:

obtaining multiple data labels from an e-commerce platform, a department that is a sub-division of the e-commerce platform, and a provider of a product or service; and

integrating the multiple data labels.

The method may further comprise:

selecting the one or more data labels from the multiple data labels according to the search term and a classification of the user.

The method may further comprise requesting the client terminal to present the one or more data labels and the one or more search results concurrently.

For example, the one or more data labels include one or more red envelopes or coupons.

The present disclosure provides a system comprising:

a distribution server that receives a search term from a client terminal and distributes one or more data labels to the client terminal according to the search term.

The system may further comprise the client terminal that receives the search term from a user.

The system may further comprise a search server that receives the search term, and returns one or more search results to the client terminal according to the search term.

For example, the distribution server and the search server are integrated into a same server.

For example, the client terminal displays the one or more data labels and the one or more search results concurrently.

The system may further comprise a user information database that stores a user information database that stores user information of the user.

The distribution server obtains the user information of the user from the user information database and distributes the one or more data labels to the client terminal according to the obtained user information and the search term.

The distribution server determines a classification of the user according to the user information, and distributes the one or more data labels according to the determined classification and the search term.

For example, the user information includes at least one of:

historical purchase record of the user;

historical saving record of the user; and

historical visiting record of the user.

The system may further comprise a data label integration server that obtains multiple data labels from an e-commerce platform, a department that is a sub-division of the e-commerce platform, and a provider of a product or service, and integrates the multiple data labels.

The present disclosure further provides one or more computer readable media storing thereon computer-readable instructions, that when executed by one or more processors, cause the one or more processors to perform acts comprising:

classifying a user of an e-commerce platform or website; and

distributing different data labels to the user according to different classifications of the user, the different data labels including different coupons.

As shown from the technical solutions of the above techniques, the system, server, and client terminal provided by the present disclosure push corresponding data label to the user according to the search term input by the user and/or the classification of the user, thereby improving the probability that the data label is viewed and used by the user and increasing the active degree of the e-commerce platform.

### BRIEF DESCRIPTION OF THE DRAWINGS

In order to more clearly illustrate the technical solutions in the embodiments or the conventional techniques of the present disclosure, the drawings for illustrating the embodiments are briefly introduced as follows. It is apparent that the drawings only describe some of the embodiments of the present disclosure. One of ordinary skill in the art may obtain other figures according to the FIGs without using creative efforts.

FIG. 1 is a schematic diagram of an example data label distribution system according to an example embodiment of the present disclosure;

FIG. 2 is an example presentation of data label according to an example embodiment of the present disclosure;

FIG. 3 is another example presentation of data label according to an example embodiment of the present disclosure:

FIG. 4 is another diagram that shows multiple input methods provided by the client terminal according to an example embodiment of the present disclosure;

FIG. 5 illustrates an example coupon in the user account according to an example embodiment of the present disclosure;

FIG. 6 is a diagram that shows an example classification of the users by the distribution server according to an example embodiment of the present disclosure;

FIG. 7 is a diagram that shows an example scenario when the user conducts search according to an example embodiment of the present disclosure;

FIG. 8 is a diagram that shows that the server for data label integration integrates the data label according to an example embodiment of the present disclosure;

FIG. 9 is a diagram of presentation of data label according to an example embodiment of the present disclosure;

FIG. 10 is a diagram of an example interface that the coupon is collected by the user according to an example embodiment of the present disclosure;

FIG. 11 is a diagram that the user purchases product according to an example embodiment of the present disclosure;

FIG. 12 is a diagram that shows a combination of coupons according to an example embodiment of the present disclosure;

FIG. 13 is a flowchart of an example method for distributing coupons according to an example embodiment of the present disclosure;

FIG. 14 is a diagram of an example client terminal according to an example embodiment of the present disclosure; and

FIG. 15 is diagram of an example user interface according to an example embodiment of the present disclosure.

### DETAILED DESCRIPTION

In conjunction with the following FIGs of the present disclosure, the technical solutions in the embodiments of the present disclosure will be described. Apparently, the described embodiments merely represent some of the embodiments of the present disclosure and are not to be construed as limiting the present disclosure. All other embodiments obtained by those of ordinary skill in the art based on the embodiments of the present disclosure fall within the scope of protection of the present disclosure.

The present disclosure provides a data label distribution system, including a search server, a distribution server, and at least one client terminal. The client terminal communicates with the distribution server. The client terminal receives an input of a search term. The distribution server receives the search term from the client terminal and distribute the data labels to the client terminal according to the search term. The search server receives the search term, and returns the search results to the client terminal according to the search term. The client terminal display both the data label and the search result concurrently. The search term may be related to a product. The search term may also be related to a service.

The system may further include a user information database that communicates with the distribution server and stores the user information of the users of the e-commerce platform or shopping platform.

The distribution server obtains the user information of the user that inputs the search term from the user information database and distributes the data labels to the client terminal according to the obtained user information and the search term.

The distribution server determines the classification of the user according to the user information, and distributes the data labels according to the determined classification and the search term.

The user information includes at least one of the historical purchase record of the user, the historical saving record of the user, and the historical visiting record of the user.

The data label distribution system may further include a data label integration server that communicated with the distribution server, obtains the data labels from the platform, industries, and/or manufacturers, and integrates the obtained data labels.

The distribution server obtains multiple data labels from the data label integration server, determines one or more data labels from the multiple data labels according to the search term, and distributes the one or more data labels to the client terminal.

The client terminal may receive the input by one of the following methods: text input, voice or audio input, code scanning input, and image input.

The search server and the distribution server may be the same server.

The present disclosure also provides a server, which includes a communication module and a processor. The communication module establishes a communication connection to transmit data and the processor controls the communication module to receive the search term, and distribute the data bale to the client terminal according to the search term.

The processor, according to the user information, determines the classification of the user, and distributes the data labels to the client terminal according to the determined classification and the search term.

The user information includes at least one of the historical purchase record of the user, the historical saving record of the user, and the historical visiting record of the user.

The processor may also control the communication module to obtain multiple data labels from the data label integration server, and determine one or more data labels from the multiple data labels according to the search term, and distribute the one or more data labels to the client terminal.

The present disclosure provides a client terminal. The client terminal includes an input device, a communication module, a display device, and a processor. The input device receives the search term input by the user. The communication module establishes the communication connection and transmits data. The display presents information. The processor controls the communication module to send the search term received by the input device to the distribution server and the search server, controls the communication module to receive the data label pushed by the distribution server according to the search term and the search result returned by the search server according to the search term, and controls the display to present the data label and the search result concurrently.

The client terminal may receive the input by one of the following methods: text input, voice or audio input, code scanning input, and image input.

The display may display the data labels by using the floating layer.

The present disclosure provides a data label distribution method, which includes receiving the search term sent by the client terminal, distributing the data label and the search result corresponding to the search term to the client terminal.

The distribution of the data labels may include determining the classification of the user according to the user information, and distributing the data labels to the client terminal according to the determined classification and the search term.

The user information includes at least one of the historical purchase record of the user, the historical saving record of the user, and the historical visiting record of the user.

The method may further include obtaining the data labels from the platform, the industry, and the manufacturer, and integrating the obtained data labels.

The present disclosure also provides another data label distribution method, which includes classifying the users of the platform, and distributing different labels according to a classification of a respective user.

The classification of the user may be determined according to at least one of the historical purchase record of the user, the historical saving record of the user, and the historical visiting record of the user. Different classifications of users may correspond to different data labels.

The present disclosure also provides another data label distribution method, which include receiving the search request from the user, determining the classification of the user in response to the search request, and distributing the data label corresponding to the classification to the user.

The determination of the classification of the user may include obtaining the user information of the user, and determining the classification of the user according to the user information of the user.

The user information includes at least one of the historical purchase record of the user, the historical saving record of the user, and the historical visiting record of the user. Different classifications of users may correspond to different data labels.

The present disclosure provides a data label display method, which includes receiving the search term input by the user, displaying the data label distributed by the distribution server according to the search term, and display the search result corresponding to the search term concurrently with the data label.

The receiving of the search term input by the user may include receiving the input by one of the following methods: text input, voice or audio input, code scanning input, and image input.

The present disclosure provides a user interaction method applicable at the client terminal, which includes receiving the search term in put by the user at a first region of a user interface, displaying the search result corresponding to the search term at a second region of the user interface, and displaying the data label matching the search term at a third region of the user interface. For example, the first region, the second region, and the third region may be on a same display page of the user interface. For another example, the second region and the third region are on the same display of the user interface.

The data label may be matched according to the user information of the user and the search term.

The user information includes at least one of the historical purchase record of the user, the historical saving record of the user, and the historical visiting record of the user.

The present disclosure provides a data label distribution system, which includes the distribution server and at least one client terminal. The client terminal communicates with the distribution server. The client terminal receives the search term and sends the search term to the distribution server. The distribution server receives the search term, and distributes the data label to the client terminal according to the search term.

The client terminal displays the data labels for the user to collect.

The client terminal, when displaying the data labels, display the search results corresponding to the search terms concurrently.

The data label distribution system may also include the user information database that communicated with the distribution server and stores the user information of the users of the platform.

The distribution server receives the user information of the user that inputs the search term from the user information database, and distributes the data labels to the client terminal according to the obtained the user information and the search term.

The client terminal displays the data labels to be collected by the user.

The client terminal displays the data labels and the search results corresponding to the search term concurrently.

The data label distribution system may further include a user information database that communicated with the distribution server and stores the user information of the user of the platform.

The distribution server obtains the user information of the user that inputs the search term from the user information database, and distributes the data labels to the client terminal according to the obtained user information and the search term.

The distribution server determines the classification of the user according to the user information, and distributes the data labels to the client terminal according to the determined classification and the search term.

The user information includes at least one of the historical purchase record of the user, the historical saving record of the user, and the historical visiting record of the user.

The data label distribution system may further include a data label integration server that communicated with the distribution server, obtains the data labels from the platform, industries, and/or manufacturers, and integrates the obtained data labels.

The distribution server obtains multiple data labels from the data label integration server, determines one or more data labels from the multiple data labels according to the search term, and distributes the one or more data labels to the client terminal.

The client terminal may receive the input by one of the following methods: text input, voice or audio input, code scanning input, and image input.

The present disclosure provides a client terminal. The client terminal includes an input device, a communication module, a display device, and a processor. The input device receives the search term input by the user. The communication module establishes the communication connection and transmits data. The display presents information. The processor controls the communication module to send the search term received by the input device to the distribution server, controls the communication module to receive the data label pushed by the distribution server according to the search term. The display present information. The processor controls the display to present the data labels to be collected by the user.

The present disclosure provides a client terminal. The client terminal includes an input device, a communication module, a display device, and a processor. The display displays a user interface including a first region, a second region, and a third region. The client terminal receives the search term in put by the user at the first region of the user interface, displays the search result corresponding to the search term at the second region of the user interface, and displays the data label matching the search term at the third region of the user interface. The data labels are matched according to the search term. Alternatively, the data labels are matched according to the user information and the search term.

The user information includes at least one of the historical purchase record of the user, the historical saving record of the user, and the historical visiting record of the user.

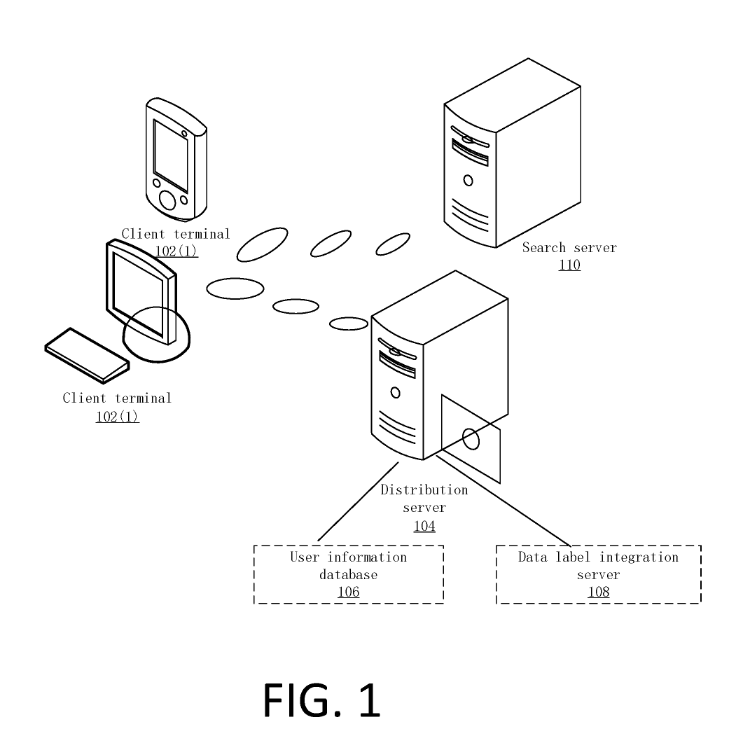

Referring to FIG. 1, the present disclosure provides a data label distribution system. The system includes one or more client terminals 102, such as client terminal 102(1), client terminal 102(2), and a distribution server 104. The client terminal 102 communicates with the distribution server 104.

In another example embodiment, the system may further include a user information database 106. The user information database 106 communicates with the distribution server 104. The distribution server 104 may include one or more servers or be integrated into one server. The distribution serer 104 communicates with the client terminal 102 and the user information database 106.

In another example embodiment, the system may further include a data label integration server 108. The data label integration server 108 communicates with the distribution server 104. The data label integration server 108 may include one or more servers or be integrated with the distribution server 104 into one server.

In another example embodiment, the system may further include a search server 110. The search server 110 receives the search term, and returns the search result to the client terminal 102 according to the search term. Further, the search server 110 and the distribution server 104 may be implemented by one server, or through two servers, to which the present disclosure does not impose restriction.

For example, the client terminal 102 may be a portable device, such as a cell phone, a tablet, etc. The client terminal 102 may also be a desktop device, such as a personal computer (PC), an all-in-one computer, etc.

The user may use different client terminal 102 at different scenarios to obtain the data labels distributed by the distribution server 104 to complete one or more methods of the present disclosure.

The data label may be a coupon, a discount, etc. The coupon may be used by the user to reduce payment when purchasing a product or service, or a voucher when receiving the product or service for free. The discount may be used by the user to have certain discount when purchasing the product or service. By distributing the data label, the active degree of the user may be increased.

In an example scenario, the e-commerce platform may push different data labels to different classifications of users according to the respective classification of the respective user. For example, the e-commerce platform intends to encourage users to shop, and increase the activity degrees of the users, and thus may distribute the data labels to the users. For instance, different data labels are prepared for different groups of users, such as new user data label, regular user label, churning user data label. For instance, the data label is coupon. The coupon for new user, the coupon for regular user, and the coupon for churning user are prepared. The distribution server 104 may push different types of data labels to the different client terminals 102 according to the classifications of the users.

In another example scenario, when the user intends to purchase the product or service, or intentionally searches certain product or service, the user needs to conduct search. The user may use the client terminal 102 to log into the corresponding shopping app or shopping website to conduct search to obtain the relevant information of the target product or service and then determine whether to purchase such product or service. The data label is then provided to the user according to the product or service searched by the user, or a classification of the user and the product or service searched by the user to effectively increase the active degree of the user. For example, the client terminal 102 presents a search interface of a shopping app. The user inputs the search term into the search box of the search interface. After the user clicks return button or confirmation, the proper data label is pushed to the user according to the search term. Thus, the reasonable data label is effectively pushed to the user in real time. As the data label is pushed according to the classification of the user and/or the product or service searched by the user, the probability that the data label is collected and used by the user is high, thereby effectively increasing transaction successful rate.

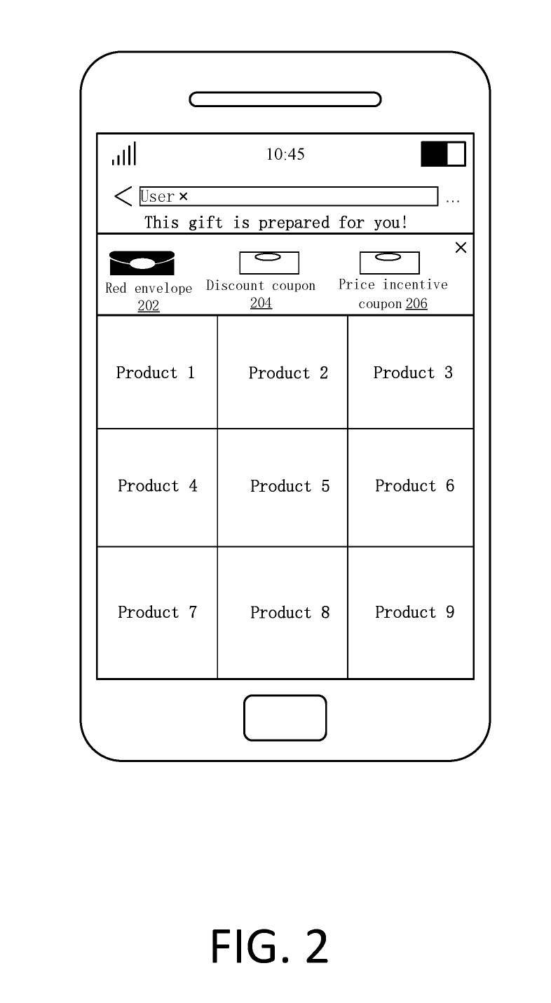

FIG. 2 shows an example presentation of the data label and the search result. The data labels include a red envelope 202, a discount coupon 204, and a price incentive coupon 206. The red envelope 202 provides certain amount of cash or virtual money for the user to the use. The discount coupon 204 offers a discount of a product or service to the user. The price incentive coupon 206 offer an incentive for the user to make purchase such that after the user spends a certain amount of money the user receives a reduction of the purchase price. The search result include product 1, product 2, product 3, product 4, product 5, product 6, product 7, product 8, and product 9. In FIG. 2, a separate region is selected in the user interface of the search result to present the data labels.

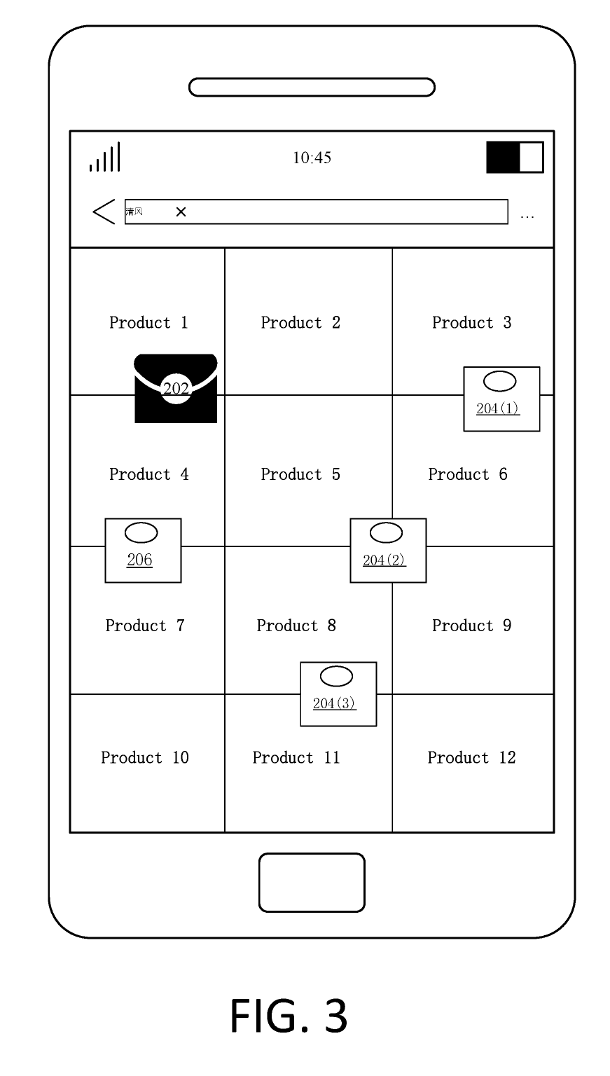

Alternatively, FIG. 3 shows another example presentation of the data label and the search result. In FIG. 3, the data labels, such as the red envelope 202, multiple discount coupons 204(1), 204(2), . . . , 204 (n), n maybe any integer, and the price incentive coupon 206, are presented in floating windows. The user may click a respective coupon to collect the data label.

The client terminal 102 receives the user information and the search term input by the user, and sends the received user information and the search term to the distribution server 104. The search terms relate to various products on the e-commerce platform. The products may be physical products or intangible products. For example, the products may be physical products for clothes, foods, housing, and transportations, or intangible products for services. With respect to the client terminal 102, when the search result is obtained after the search term is input, the corresponding data label is also displayed. The data label may be a coupon that the user uses to shop the product in the search result. The user information may be the user name of the user, or the user identity information of the user. The search term may be a product brand, a product category, or detailed product description information including a series of adjectives and nouns. For example, the user information may be the user name such as Zhang San, a two-dimensional barcode corresponding to the identification of Zhang San, a serial number corresponding to Zhang San, or any identification that identifies the current user. The search term, for example, may be air conditioner, Gree™ air conditioner, freezer, 1.5P inverter air conditioner, energy-saving air conditioner, etc.

The client terminal 102 may use different methods to receive the search term. For example, the user may use text input, audio input, QR code scanning input, image input to input the search term. If the text input is used, the client terminal 102 may use the text input by the user as the search term and send it to the distribution server 104. If the audio input is used, the client terminal 102 identifies the text in the audio, uses the identified text as the search term, and sends it to the distribution server 104. If the QR scanning code input is used, the client terminal 102 may use the name of the scanned object as the search term and send it to the distribution server 104, or send the code (such as the two-dimensional code, barcode) to the distribution server 104. If the image input is used, the client terminal 102 uses the name of the object identified from the scanned image as the search term and sends it to the distribution server 104, or provides the image to the distribution server 104. At the server side, the matching products in the stored products are identified, and the highly matching products are displayed as the search result. Meanwhile, the distribution server 104 uses the coupons for these products as to-be-distributed coupons to push them to the user. From the above methods, the user may use the client terminal 102 to efficiently and conveniently search the products.

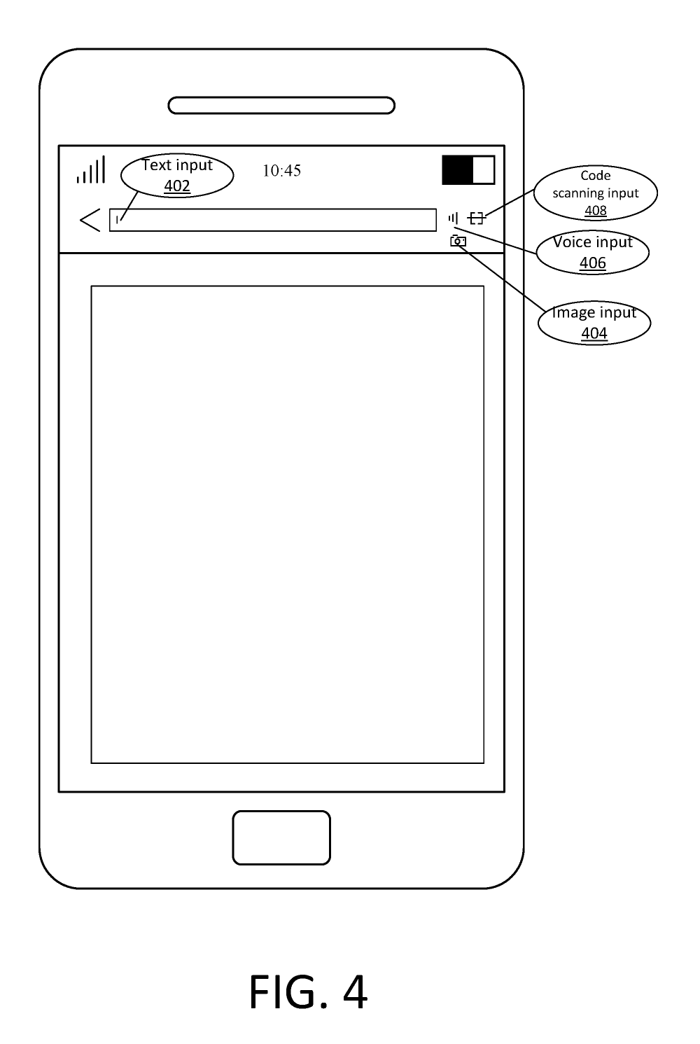

For example, the user interface displayed by the client terminal 102 to the user may be as shown in FIG. 4. The user interface provides text input 402, image input 404, voice input or audio input 406, and code scanning input 408 such as the two-dimensional code scanning input. The user may input the search term such as air conditioner to the search box to by text input 402 or voice input 406. The user may also scan the image of the air conditioner via image input 404, or scan the two-dimensional code of the air conditioner via the code scanning input 408 to input the search term. After the search term is input, the user may click confirmation or enter button to complete inputting the search term.

In an example embodiment, after the client terminal 102 obtains the search term input by the user and pushes the corresponding data label to the user, a separate display region as shown in FIG. 2 or a floating window as shown in FIG. 3 may be used. With respect to the separate display region as shown in FIG. 2, it may be set as a floating layer. When the user does not want to such recommendation information, the user may click the close button on the top right corner in the data label display region as shown in FIG. 2 to exit. Then the user interface does no longer display the pushed data labels and only displays the search result.

In an example embodiment, after the client terminal 102 detects that the user collects the data label, the client terminal 102 monitors whether the user successfully makes order. If the user does not make order and the user changes to another search term for search, the data label corresponding to the new search term is pushed. That is, according to different search terms input by the user, different data labels are presented to user. The displayed data label may be a single data label or a combination of multiple data labels. Different data labels are recommended for different search terms input by the user, thereby effectively increasing the shopping active degree of the user. As the data labels are targeted, it is more likely that the pushed data labels are collected and used by the user. Different choices may be provided to the user by pushing a combination of multiple data labels. Thus, the user may obtain the coupon and discount to a maximum extent according to needs and the active degree of the user is increased.

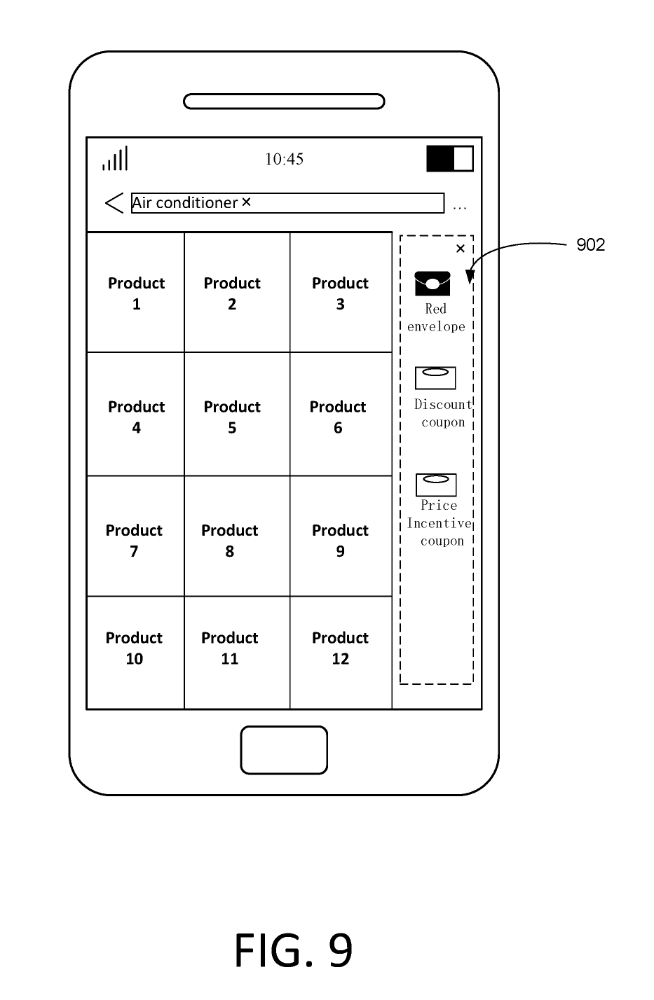

In an example embodiment, as shown in FIG. 9, the client terminal, after the user conducts search, presents a particular data label region 902 in the user interface to display the data label. During the presentation, the client terminal 102 monitors whether the user successfully makes order. If the user successfully makes order, such data label is no longer displayed, thereby avoiding wasting resources and preventing the bad reflections from the user. Further, to provide more control to the user, the particular data label region may also have a close button. The user may click the close button to close the data label region 902.

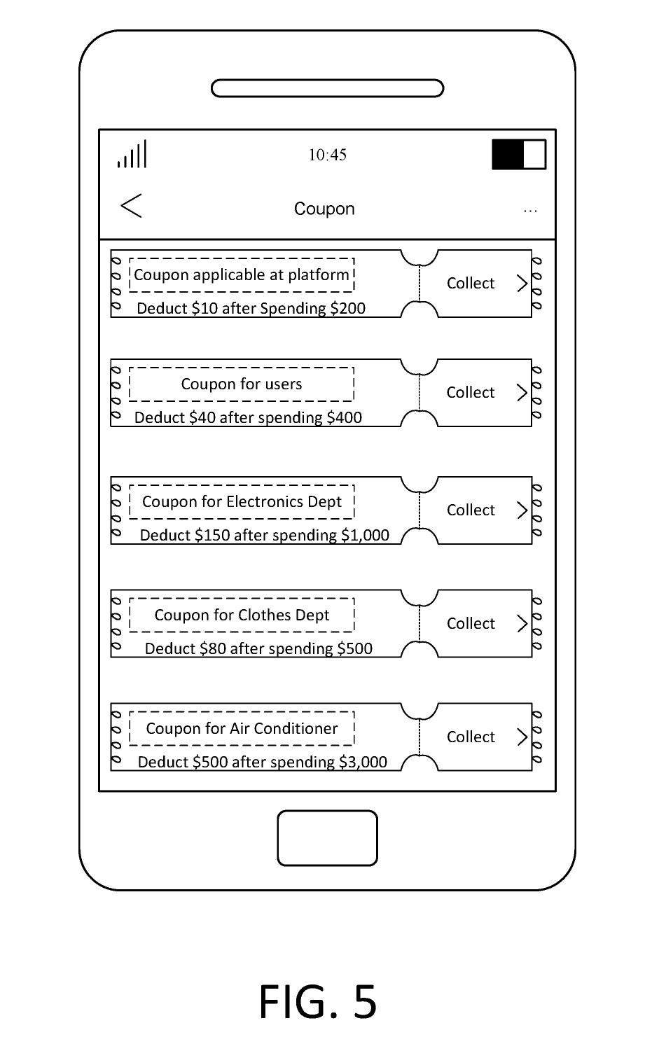

In another example embodiment, the client terminal 102 may be used as the entity that receives the data label. That is, the client terminal 102 receives the data label pushed by the distribution server 104. The data labels may be obtained without inputting the search term. That is, the distribution server 104 actively pushes the data labels to the client terminal 102. The distribution server 104 may push the data labels according to the classification of the user, or according to the historical visiting behavior or historical purchase history. Referring to FIG. 5, the client terminal 102 may use the following methods to display the pushed data labels. In the example of FIG. 5, the data label is coupon. The user may collect the coupon according to needs or interests. As the data labels are pushed according to the classification of the user, the pushed result may more fit the user's actual needs. For example, if the user Zhang San is used to purchase cleaning suppliers on the e-commerce platform, and the user Li Si is used to purchase electronics on the e-commerce platform, the coupon for cleaning suppliers is pushed to Zhang San and the coupon for electronics is pushed to Li Si. Thus, the probability that the coupon is collected by the user is increased.

The distribution server 104 may distribute the data labels to the user when the user searches product, to implement targeted distribution of the data labels. The distribution server 104 may provide different data labels according to the classification of the user. The classification of the user may use big data processing to conduct cluster analysis of different users of the platform, to conclude the characteristics corresponding to different classifications. The users are then classified based on the characteristics and the classifications of the users are determined. For example, after analyzing the behavior characteristics of the multiple users of the platform, the users are classified into the following types:
(1) New user: the user newly registers the user account and has not conducted transaction;
(2) Potential churning user: the user has not logged into account to view or shop for a first preset threshold of time. For example, the user has not viewed or shopped for 7 days on the platform;
(3) Churning user: the user has not logged into account to view or shop for a second preset threshold of time. The second preset threshold of time is longer than the first prese threshold of time. For example, the user has not viewed or shopped for 30 days on the platform.
(4) Normal user: The user other than those listed above normally shops on the platform.

After determining the behavior characteristics of the different classification users, the classification of the respective user is determined based on the historical visiting records of the respective user.

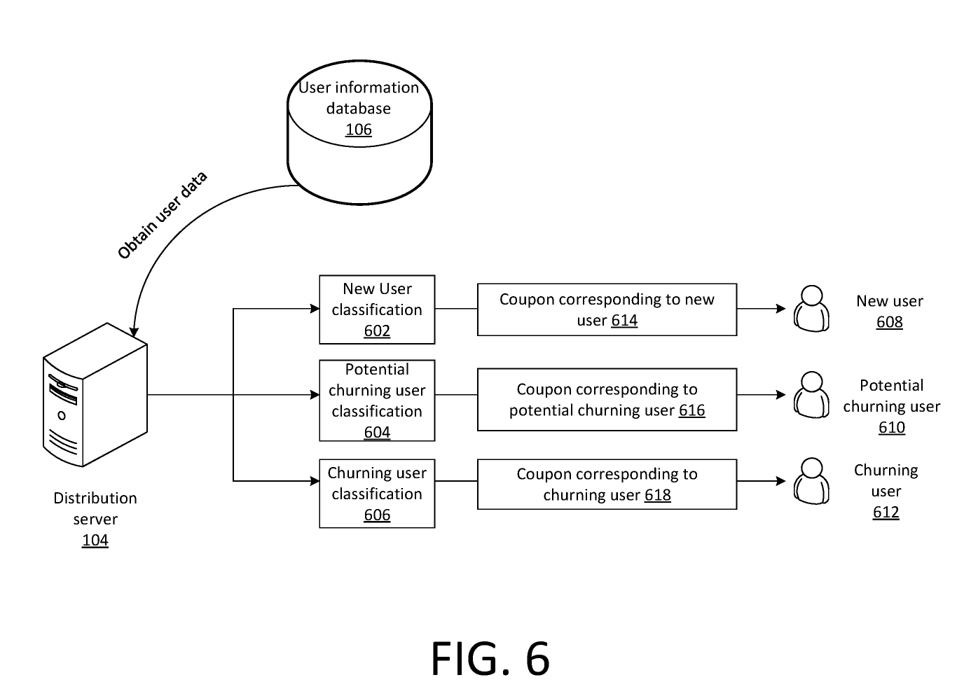

Referring to FIG. 6, the distribution server 104 analyzes various behavior data stored in the user information database 106 to classify the users into different classifications including new user classification 602, potential churning user classification 604, and churning user classification 606. To increase the active degree of the new user 608, potential churning user 610, and churning user 612, the distribution server 104 may distribute the coupon corresponding to new user 614 to the new user 608, the coupon corresponding to potential churning user 616 to the potential churning user 610, and the coupon corresponding to the churning user 618 to the churning user 612. That is, different types of coupons are distributed according to the classifications of the users. Compared with the coupons pushed to the normal user, the new user and the potential churning user that need more attention and activation may be pushed more coupons, coupons with more incentives, or different types of coupons, to improve the active degree of these types of users.

It should be noted that the above classifications are just illustrative. In the actual implementation, other classification methods may be used. The present disclosure does not limit the detailed classification types and methods.

In an example embodiment, the distribution server 104, according to the user characteristics of different classifications of users, provides targeted data labels to the users. For example, with respect to the new user, considering their habits, the shopping of the new user may focus in certain departments, such as supermarket department, fresh department, or group purchasing department. Then the coupons for these departments may be pushed to the new user. With respect to the potential churning user, the user behaviors including clicking, saving, purchasing, and follow-up purchasing in the preset past time period may be analyzed to provide coupons suitable for them. In another example embodiment, the coupons may be intentionally pushed according to the user level and the user age of the potential churning user group, instead of pushing the coupons to all user without different treatments. The data labels are pushed according to the actual situation and need of each user. Thus, individualized pushing is realized and the probability that the pushed data label is collected and used is largely increased.

In an example embodiment, the data label may be the red envelope, the discount coupon, or the price incentive coupon. The red envelope coupon is the coupon that is directly applied as payment. For the example of the $5 red envelope, when check out, the total payment is $100 and the $5 is deducted from $100. That is, only $95 is paid. The discount coupon is the coupon used for discount. For the example of 20% off discount coupon, when check out, the total payment is $1,000 and with 20% off the final payment is $800. The price incentive coupon is used to deduct certain amount from the payment when the payment reaches a certain threshold. For the example of the coupon that deducts $200 after spending $2,000, when check out, if the payment is $1,500, the coupon cannot be used; if the payment is $2,300, the coupon is applied and only $2,100 needs to be paid.

In an example embodiment, with respect to the e-commerce platform, the data label may be a platform coupon provided by the platform. The data label may also be a department coupon provided by a department of the platform. For example, the electric appliance department provide the coupon for electric appliance. The clothing department provides the coupon for clothing. According to the incentives provided by the coupons, the distribution server 104 pushes the most favorable coupon to the user according to the classification of the user or the actual need of the user.

In an example embodiment, the distribution server 104 pushes the data labels to the users when the user inputs the search term to conduct search. The distribution server 104 obtains the user information and the search term input by the user, purposefully pushes the data labels to the user according to the user information and/or the search term input by the user, instead of randomly pushing the data label. For example, the user Zhang San is searching air conditioner, the currently available coupons are analyzed to determine the most favorable combination of coupons to be sent to Zhang San. Further, by reference to Zhang San's previous purchase history, it is determined that Zhang San like Gree™ air conditioner. Then the coupon for Gree™ air conditioner is selected in priority and pushed to Zhang San. That is, according to the historical purchasing record of the user and the currently searched targeted product, the coupons are selected and pushed to the user. According to the actual situation of the user, and the current search target of the user, the coupons are timely and selectively pushed to the user, thereby largely increasing the active degree of the user.

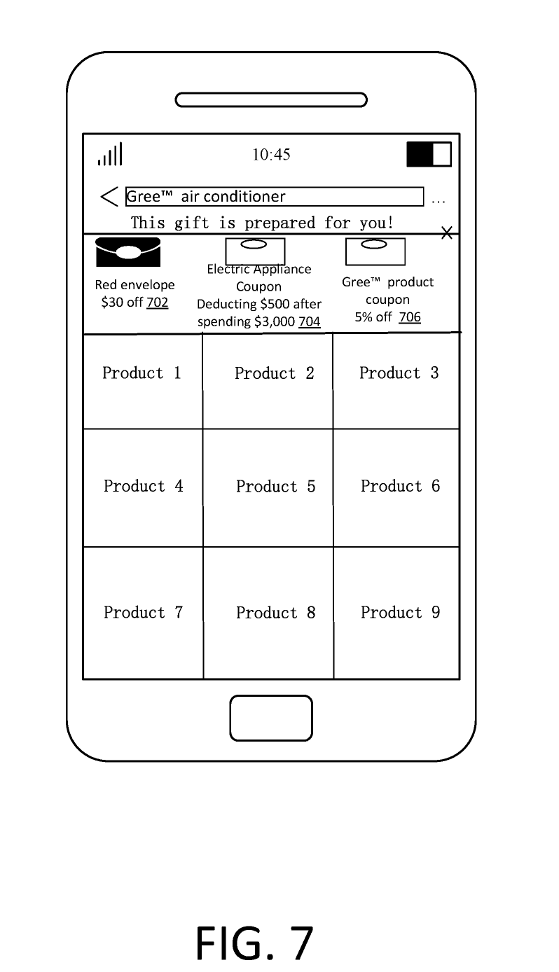

Referring to FIG. 7, the user Zhang San searches Gree™ air conditioner. The system analyzes the historical visit record, historical saving record, and historical purchasing record, analyzes the coupons available for the user to purchase the air conditioner, and determines that a combination of the red envelope 702 such as $30 off, the electric appliance coupon 704 such as deducting $500 after spending $3,000, and the Gree product coupon 706 such as 5% off is appropriate for the user. As shown in FIG. 7, after the user Zhang San searches Gree™ air conditioner, three coupons 702, 7024, and 706 are pushed to him for selection.

It should be noted that the above listed method is just an example illustration. Some other methods may be used to push coupons. For example, as shown in FIG. 2, the coupons include red envelope 202, discount coupon 204, and price incentive coupon 206. After clicking the icon corresponding to each of 202, 204, and 206, a corresponding coupon set including multiple coupons may be presented. The user can select needed or favorable coupon from the coupon set to collect. The present disclosure does not impose limitation.

The user information database 106 may be a server that has store functionality. The user information database 106 stores the purchase record of the user, the visiting record of the user, and the saving record of the user. The saving record, the visiting record, and the saving record of the user may be stored by using a user identification corresponding to the visiting record and the purchasing record. A relational database may be established to store the data by storing the corresponding relationship between the user and the visiting record, the purchase record, and the saving record. When the distribution server 104 extracts data, it may extract the visiting record of a particular user, or the visiting records and purchase records of all users, to classify the users in the platform and push different types of data labels.

The data label integration server 108 integrates different coupons. The integrated coupons may include platform coupon, department coupon, etc. That is, various platform coupons provided by the platform or department coupons from various departments or industries are stored and integrated centrally. When storing, the coupons are classified and stored in the database according to the type of its corresponding product or the promotion incentive. The distribution server 104, when pushing the data labels, obtain the corresponding data labels from the data label integration server 108.

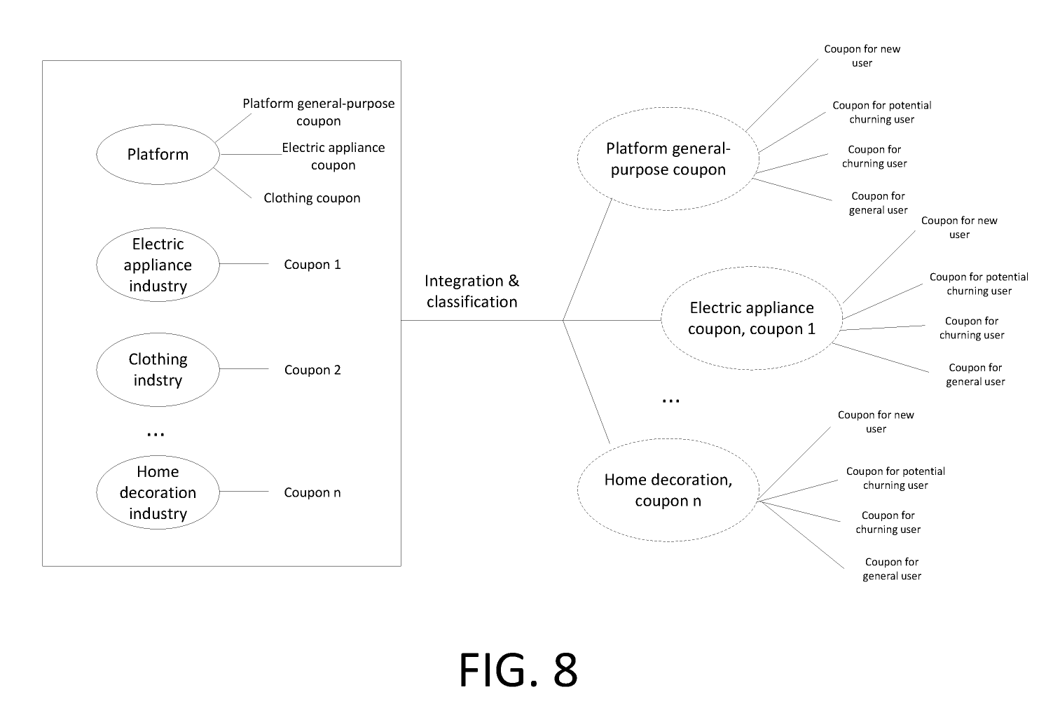

Referring to FIG. 8, the data label integration server integrates the general-purpose data label (such as the coupon that is applicable to all types of products), the electric appliance data label (such as the coupon that is applicable to the electric appliance), the clothing data label (such as the coupon that is applicable to the clothing), which are provided by the platform, and the industry-specific data labels provided by industries, departments, manufacturers, or third-party providers, such as the coupon provided by the electric appliance industry, the coupon provided by the electric applicant industry, the coupon provided by the clothing industry, and the coupon provided by the home decoration industry. The data label integration server 108 may classify the general-purpose data label provided by the platform as the first classification of coupon, the electric appliance data label provided by the platform and the data label provided by the electric appliance industry as the second classification of coupon, the clothing data label provided by the platform and the data label provided by the clothing industry as the third classification of coupon, etc.

In another example embodiment, the data label integration server 108 may further divide a particular classification of coupon. For example, the data label for electric application is further divided into: the coupon for all electric appliance, the coupon for air conditioner only, the coupon for refrigerator only, the coupon for air conditioner and refrigerator only. Similarly, the data label integration server 108 may integrate and classify the data labels according to the amounts of the values of the data labels.

Through the classification and integration of the data labels, it is convenient and easy for the distribution server 104 to obtain the data labels of the corresponding classifications, when the distribution server 104 requests the data labels from the data label integration server 108 according to the search term input by the user, the classification of the user, or the historical visiting and purchasing record of the user.

In an example implementation, the user Zhang San inputs the search term “Gree™ air conditioner.” The search results are displayed at the user interface of the client terminal. Meanwhile, the coupon information is also displayed at the user interface of the client terminal. The distribution server 104, after analyzing the historical purchase records of Zhang San, determines that the purchase range of Zhang San for air conditioner is around $3,000. Further, the distribution server 104 obtains the coupon information from the data label integration server 108. After analyzing, the distribution server 104 determines that there is red envelop $30 off 702, and electric appliance coupon that deducts $500 after spending $3,000 704 applicable to Zhang San. Further, the distribution server 104 matches the coupon provided by the manufacturer of Gree™ air conditioner, i.e. Gree™ product coupon 5% off 706, from the data label integration server 108. After analyzing, the distribution server 104 determines that it is appropriate to push a combination of the three coupons, i.e., red envelop $30 off 702, electric appliance coupon that deducts $500 after spending $3,000 704, and Gree™ product coupon 5% off 706, to the user Zhang San. Thus, the distribution server 104 pushes the three coupons to the user, and displays them at the client terminal 102. From the user experience of Zhang San, by one search, both the search results and the individualized pushed coupons are presented at the user interface, thereby reducing the difficulty of Zhang San to obtain the coupon, improving the user experience, and facilitating the user to purchase products.

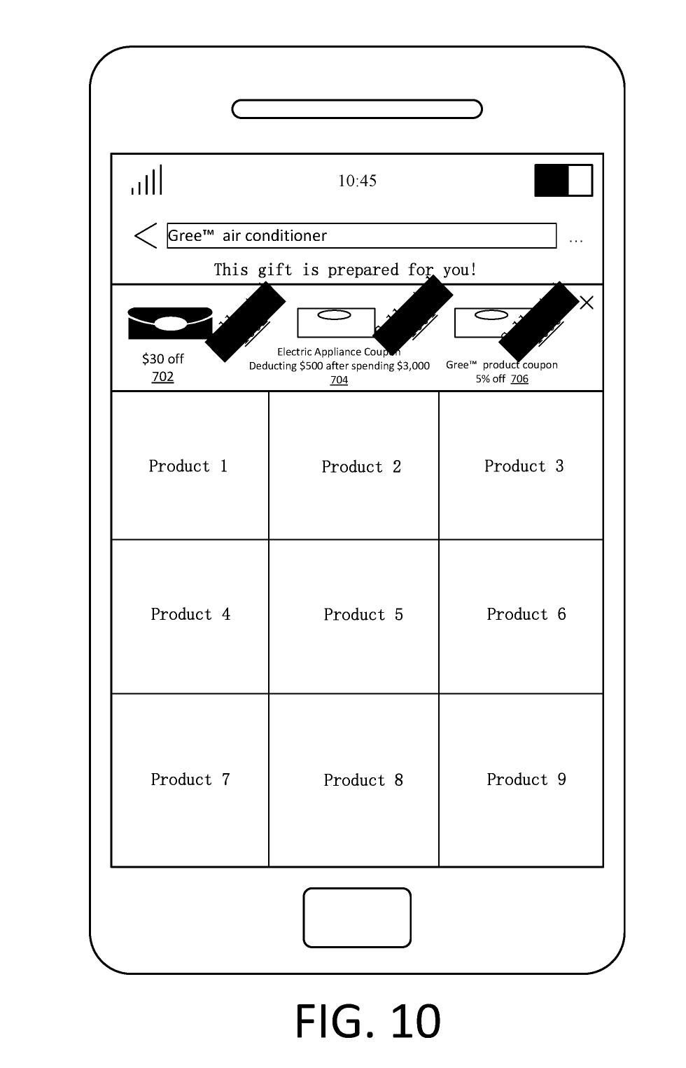

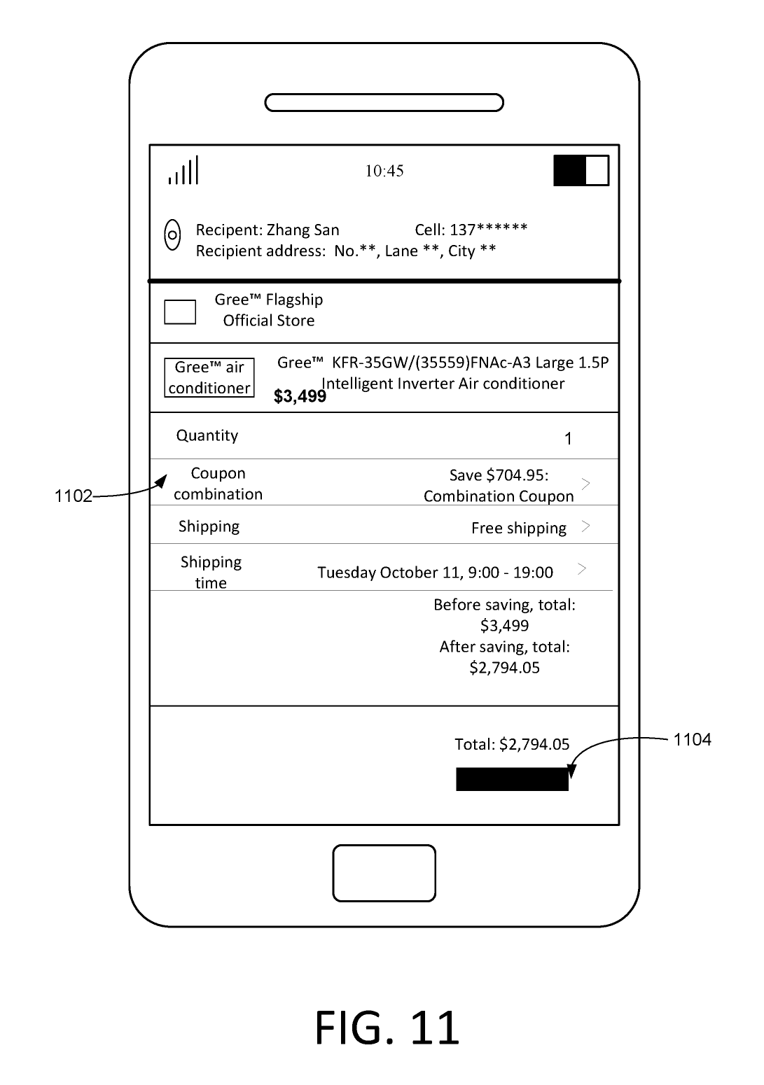

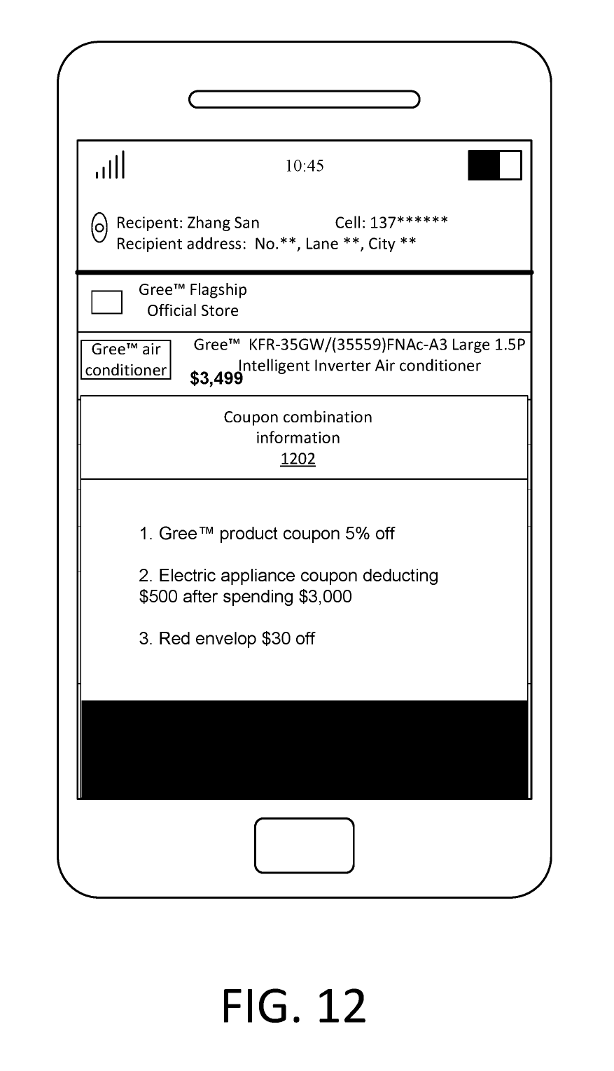

Referring to FIG. 10, after Zhang San clicks to collect the red envelop $30 off 702, the user interface displays that the red envelop $30 off 702 is collected 1002. After Zhang San clicks to collect the electric appliance coupon that deducts $500 after spending $3,000 704, the user interface displays that the electric appliance coupon that deducts $500 after spending $3,000 704 is collected 1004. After Zhang San clicks to collect the Gree™ product coupon 5% off 706, the user interface displays that the Gree™ product coupon 5% off 706 is collected 1006. Considering that these three coupons may be used in combination, Zhang San selects the air conditioner from the search results. Zhang San's initial budget may be only $2,800. With the combination of the three coupons, Zhang San increases his budget to $3,500. After selection and view of the search results, Zhang San may finally choose a 1.5P intelligent inverter air conditioner with $3,499 price. After Zhang San makes order, the order interface at the client terminal may be as shown in FIG. 11. By using the coupons, Zhang San saves $704.95 and only needs to pay $2,794.05 finally. If Zhang San needs to view the detailed information of the coupons, Zhang San may click the coupon combination 1102 to view the details of the coupon combination information 1202 in FIG. 12 at the client terminal so that the user is informed of the coupons that are used.

It should be noted that the coupons are combined in the above example. In another example embodiment, the coupons may not be combined. At check out, the system may automatically choose the most favorable coupon among the coupons collected by the user to apply to the payment information. After Zhang San collected the coupons as shown in FIG. 10, Zhang San may view the coupon information in the personal coupon account, which may be presented as shown in FIG. 5.

After Zhang San confirms to purchase the product and confirms to use the coupons to make payment, Zhang San may click the submit order button 1104 to make payment and order the air conditioner.

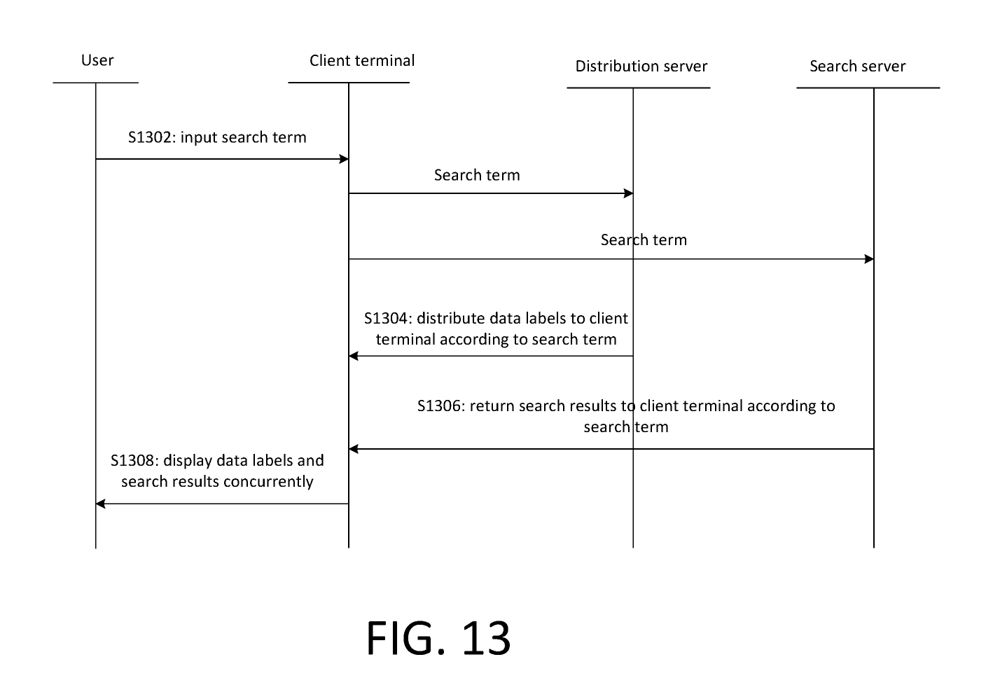

FIG. 13 is a flowchart that shows an example method for distributing coupons, which may include the following operations.

S1302, the client terminal receives the search term.

S1304, the distribution server receives the search term, and distributes the data labels to the client terminal according to the search term.

The distribution server may obtain the user information of the user that inputs the search term from the user information database, and distribute the data labels to the client terminal according to the obtained user information and the search term. For example, the distribution server determines the classification of the user according to the user information, and distribute the data labels to the client terminal according to the determined classification and the search term. For instance, the user information may include at least one of, but is not limited to, the historical purchase record of the user, the historical save record of the user, and the historical visiting record of the user.

S1306, the search server receives the search term, and returns the search results to the client terminal according to the search term.

S1308, the client terminal displays both the data labels and the search results corresponding to the search term concurrently.

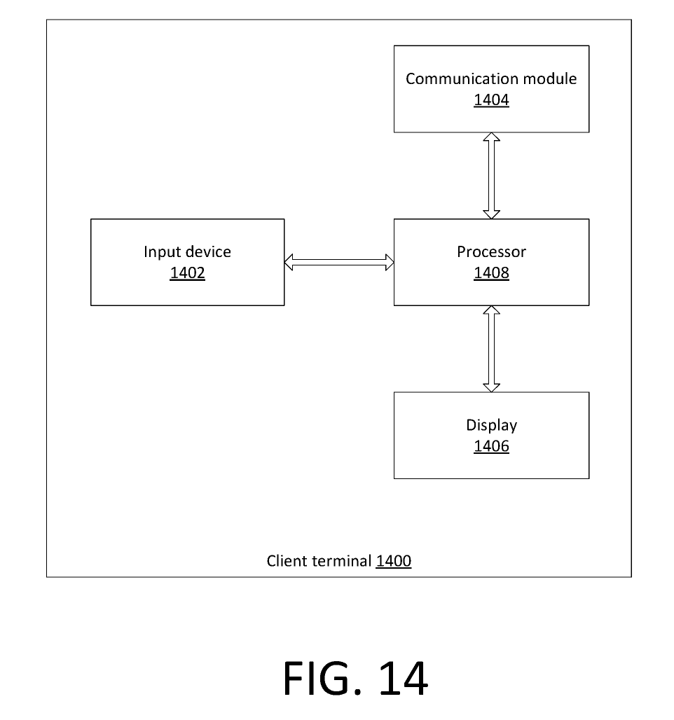

FIG. 14 shows a diagram of an example client terminal 1400. As shown in FIG. 14, the client terminal 1400 includes an input device 1402, a communication module 1404, a display 1406, a processor 1408, and computer readable media (not shown in FIG. 14). The input device 1402 receives the search term input by the user. The communication module 1404 establishes communication and conducts data transmission. The display 1406 displays information. The processor 1408 controls the input device 1402, the communication module 1404, and the display 1406.

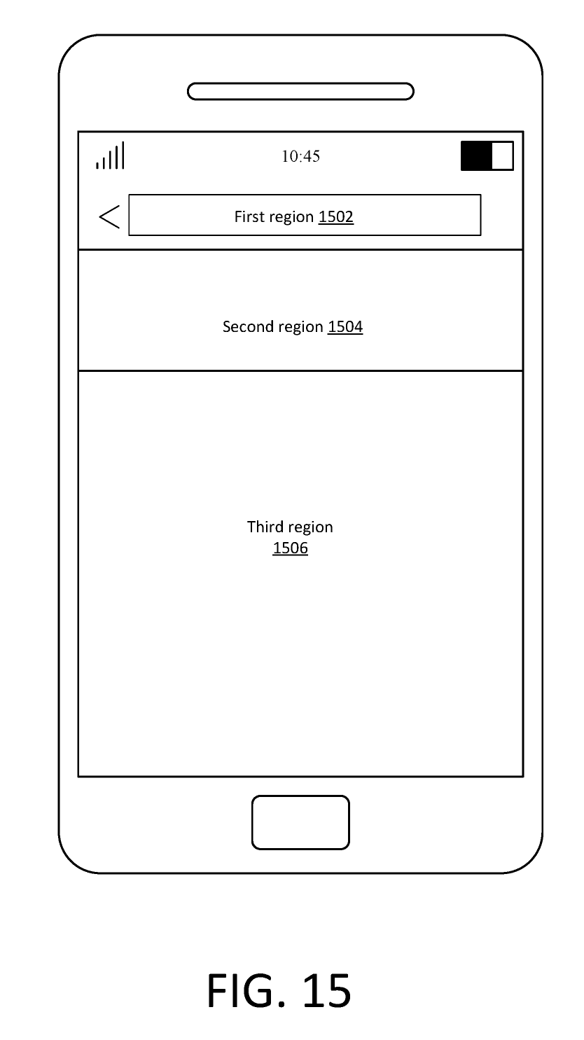

Referring to FIG. 15, the display 1406 may display a first region 1502, a second region 1504, and a third region 1506. The first region 1502 is used for receiving the search term from the user. The second region 1504 is used to display the search results corresponding to the search term. The third region 1506 is used to display the data labels.

It should be noted that the arrangement of the display regions are just examples and some other divisions and arrangements of the regions at the user interface may be accepted, and may be selected according to the actual needs and habits of the users. Further, the third region 1506 may be set as movable, or be opened or shut off to facilitate the user to adjust the size and location of the third region 1506. The present disclosure does not impose any limitation.

As shown from the technical solutions of the present disclosure, the present disclosure provides the data label distribution system and method, the data label display method, and the method for interaction between the user and the user interface at the client terminal. The server and the client terminal, according to the search term input by the user and/or the classification of the user, push the corresponding data labels to the user, thereby increasing the probability that the data labels are collected and used and improving the technical effect of increasing the active degree of the user at the platform.

In summary, the present disclosure provides a data label distribution system, method, server, and client, a data label display method, and a user interaction method applied at the client and server to distribute the coupons in a reasonable way to increase the active degree of the user.

The present disclosure provides a data label distribution system, including a search server, a distribution server, and at least one client terminal. The client terminal communicates with the distribution server. The client terminal receives a search term input by a user. The distribution server receives the search term from the client terminal and distribute the data label to the client terminal according to the search term. The search server receives the search term, and returns the search result to the client terminal according to the search term. The client terminal display both the data label and the search result concurrently. The search term may be related to a product. The search term may also be related to a service.

The server includes a communication module that establishes a communication connection to transmit data and a processor that controls the communication module to receive the search term, and distribute the data bale to the client terminal according to the search term.

The client terminal includes an input device, a communication module, a display device, and a processor. The input device receives the search term input by the user. The communication module establishes the communication connection and transmits data. The display presents information. The processor controls the communication module to send the search term received by the input device to the distribution server and the search server, controls the communication module to receive the data label pushed by the distribution server according to the search term and the search result returned by the search server according to the search term, and controls the display to present the data label and the search result.

The present disclosure provides a data label distribution method, which includes receiving the search term sent by the client terminal, distributing the data label and the search result corresponding to the search term to the client terminal.

The present disclosure also provides another data label distribution method, which includes classifying the users of the platform, and distributing different labels according to a classification of a respective user.

The present disclosure also provides another data label distribution method, which include receiving the search request from the user, determining the classification of the user, and distributing the data label corresponding to the classification to the user.

The present disclosure provides a data label display method, which includes receiving the search term input by the user, displaying the data label distributed by the distribution server according to the search term, and display the search result corresponding to the search term concurrently with the data label.

The present disclosure provides a user interaction method applicable at the client terminal, which includes receiving the search term in put by the user at a first region of a user interface, displaying the search result corresponding to the search term at a second region of the user interface, and displaying the data label matching the search term at a third region of the user interface.

The present disclosure provides a data label distribution system, which includes the distribution server and at least one client terminal. The client terminal communicates with the distribution server. The client terminal receives the search term and sends the search term to the distribution server. The distribution server receives the search term, and distributes the data label to the client terminal according to the search term.

The client terminal includes an input device, a communication module, a display device, and a processor. The input device receives the search term input by the user. The communication module establishes the communication connection and transmits data. The display presents information. The processor controls the communication module to send the search term received by the input device to the distribution server, controls the communication module to receive the data label pushed by the distribution server according to the search term.

The client terminal may also include a display that displays a user interface including a first region, a second region, and a third region. The client terminal receives the search term in put by the user at the first region of the user interface, displays the search result corresponding to the search term at the second region of the user interface, and displays the data label matching the search term at the third region of the user interface.

The foregoing description of the various example embodiments of the present application is only an application of some example embodiments of the present application. The implementations that are modified based on certain standards, models, and methods may still implement the technical solutions of the present disclosure. Certainly, the technical solutions of the present disclosure may still be achieved by variations of the above methods without using creative efforts, which are not detailed herein.

While the present application provides operations or steps as described in the example embodiments or flowcharts, more or less operations or steps may be included based on conventional or non-creative efforts. The sequence of steps enumerated in the example embodiments is only one of a number of step execution sequences and does not represent the only execution order. In the actual implementations, the computing devices such as the server or the client terminal may execute the operations or steps sequentially or in parallel (e.g., a parallel processor or a multi-threaded environment).

The computing devices, apparatuses or modules as set forth in the above embodiments may be embodied by one or more computer chips, processors, or entities, or by a product having a certain function. For the sake of convenience of description, the above devices are described in terms of functions described in various modules. The functions of the modules may be implemented in the same or more software and/or hardware when implementing the present application. Certainly, the module implementing a particular function may be implemented by multiple sub-modules or sub-units.

The method, apparatus, or module described in this application may be implemented in computer readable instructions or codes, stored on computer readable media and executable by one or more controllers, in any suitable manner. For example, the controller may be a microprocessor or processor and store the data that may be processed by the microprocessor or processor (such as software or firmware) in computer readable media. The controller may be in the form of logic gates, switches, application specific integrated circuits (ASICs), programmable logic controllers, and embedded microcontrollers that execute computer readable instructions or codes. Examples of controllers include, but are not limited to, the following microcontrollers: ARC 625D, Atmel AT91SAM, Microchip PIC18F26K20, and Silicone Labs C8051F320. Memory controllers may also be implemented as part of the memory's control logic. It will also be appreciated by those skilled in the art that, in addition to implementing the controller in purely computer readable instructions or codes, it is entirely possible to logically program the methods or steps such that the controller uses logic gates, switches, application specific integrated circuits, programmable logic controllers, and embedded Microcontrollers, etc. to achieve the same function. Thus, such a controller may be considered as a hardware component, and a device included therein for implementing various functions may also be considered as a structure within a hardware component. Thus, the device for implementing various functions as described herein may be a software module that implements the method or a structure within a hardware component.

The computer readable media include non-volatile and volatile media as well as movable and non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and can be used to store information accessible to the computing device. According to the definition herein, the computer readable media do not include transitory media, such as modulated data signals and carriers.

Some modules or units in the computing device described herein may be described in the general context of computer readable instructions executed by one or more processors, such as a program module. In general, program modules include routines, programs, objects, components, data structures, classes, and the like that perform specific tasks or implement particular abstract data types. The present disclosure may also be practiced in a distributed computing environment in which the tasks are performed by a remote processing device connected via a communication network. In a distributed computing environment, the program modules may be located in local and remote computer readable media, including storage devices.

As shown from the description of the above embodiment, it is apparent to those skilled in the art that the present disclosure may be implemented by software and the necessary hardware. Based on this understanding, the technical solution of the present disclosure may be embodied in the form of a software product, or may be embodied in the implementation of the data migration. The computer software product may be stored in a storage medium such as ROM/RAM, magnetic disk, optical disk, etc., including instructions for causing a computer device (which may be a personal computer, a mobile terminal, a server, or a network device) to implement the methods described in the various example embodiments or portions of the present disclosure.

Some modules or units in the computing device described herein may be described in the general context of computer readable instructions executed by one or more processors, such as a program module. In general, program modules include routines, programs, objects, components, data structures, classes, and the like that perform specific tasks or implement particular abstract data types. The present disclosure may also be practiced in a distributed computing environment in which the tasks are performed by a remote processing device connected via a communication network. In a distributed computing environment, the program modules may be located in local and remote computer readable media, including storage devices.

As shown from the description of the above embodiment, it is apparent to those skilled in the art that the present disclosure may be implemented by software and the necessary hardware. Based on this understanding, the technical solution of the present disclosure may be embodied in the form of a software product, or may be embodied in the implementation of the data migration. The computer software product may be stored in a storage medium such as ROM/RAM, magnetic disk, optical disk, etc., including instructions for causing a computer device (which may be a personal computer, a mobile terminal, a server, or a network device) to implement the methods described in the various example embodiments or portions of the present disclosure.

The various example embodiments in the present disclosure are described in a progressive manner, and the same or similar parts may be referred to each other, and each embodiment is focused on the differences from other embodiments. All or a portion of the present disclosure may be used in a number of general purpose or special computer system environments or configurations, such as a personal computer, a server computer, a handheld device or a portable device, a flatbed device, a mobile communication terminal, a multiprocessor system, a microprocessor-based system, a programmable electronic device, a network PC, a small computer, a large-scale computer, a distributive computing environment including any of the above systems or equipment, and so on.

While the present disclosure has been described by way of example, one of ordinary skill in the art will recognize that many variations and modifications may be made without departing from the spirit of the present disclosure. The appended claims intend to cover such modifications and variations without departing from the spirit of the present disclosure.

What is claimed is:

1. A method comprising:
receiving a search term from a client terminal;
distributing one or more data labels and one or more search results corresponding to the search term to the client terminal; the data labels being specific to a user of the client terminal; and
requesting the client terminal to display the one or more search results at a first region of a user interface of the client terminal and the one or more data labels at a second region of the user interface of the client terminal, the first region and the second region being on a same display page of the user interface.

2. The method of claim 1, wherein the distributing the one or more data labels and the one or more search results corresponding to the search term to the client terminal includes:
obtaining user information of the user corresponding to the client terminal; and
distributing the one or more data labels to the client terminal according to the user information and the search term.

3. The method of claim 2, wherein the user information includes at least one of:
historical purchase record of the user;
historical saving record of the user; and
historical visiting record of the user.

4. The method of claim 2, wherein the distributing the one or more data labels to the client terminal according to the user information and the search term includes:
determining a classification of the user according to the user information; and
distributing the one or more data labels to the client terminal according to the classification of the user and the search term.

5. The method of claim 4, wherein the classification includes at least one of:
a new user that has registered an account at a website and has not conducted transaction;
a potential churning user that has not logged into account for a first preset threshold of time;
a churning user that has not logged into the account for a second preset threshold time, the second preset threshold of time being longer than the first prese threshold of time; and
a normal user that is not classified as the new user, the potential churning user, and the churning user.

6. The method of claim 1, further comprising:
obtaining multiple data labels from an e-commerce platform, a department that is a sub-division of the e-commerce platform, and a provider of a product or service; and
integrating the multiple data labels.

7. The method of claim 6, further comprising:
selecting the one or more data labels from the multiple data labels according to the search term and a classification of the user.

8. The method of claim 1, further comprising requesting the client terminal to present the one or more data labels and the one or more search results concurrently.

9. The method of claim 1, wherein the one or more data labels include one or more red envelopes or coupons.

10. A system comprising:
a distribution server that receives a search term from a client terminal and distributes one or more data labels to the client terminal according to the search term.

11. The system of claim 10, further comprising the client terminal that receives the search term from a user.

12. The system of claim 10, further comprising a search server that receives the search term, and returns one or more search results to the client terminal according to the search term.

13. The system of claim 10, wherein the distribution server and the search server are integrated into a same server.

14. The system of claim 13, wherein the client terminal displays the one or more data labels and the one or more search results concurrently.

15. The system of claim 14, further comprising a user information database that stores a user information database that stores user information of the user.

16. The system of claim 15, wherein the distribution server obtains the user information of the user from the user information database and distributes the one or more data labels to the client terminal according to the obtained user information and the search term.

17. The system of claim 14, wherein the distribution server determines a classification of the user according to the user information, and distributes the one or more data labels according to the determined classification and the search term.

18. The system of claim 17, wherein the user information includes at least one of:
historical purchase record of the user;
historical saving record of the user; and
historical visiting record of the user.

19. The system of claim 10, further comprising a data label integration server that obtains multiple data labels from an e-commerce platform, a department that is a sub-division of the e-commerce platform, and a provider of a product or service; and integrates the multiple data labels.

20. One or more computer readable media storing thereon computer-readable instructions, that when executed by one or more processors, cause the one or more processors to perform acts comprising:
classifying a user of an e-commerce platform or website; and
distributing different data labels to the user according to different classifications of the user, the different data labels including different coupons.
